(19) United States
(12) Patent Application Publication
(10) Pub. No.: US 2006/0119321 A1
(43) Pub. Date: Jun. 8, 2006

(54) Electronic device and power supply apparatus therefor

(75) Inventors: Po-Wen Wang, Taipei County (TW); Chia-Chih Yeh, Taoyuan (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/293,320

(22) Filed: Dec. 5, 2005

(30) Foreign Application Priority Data
Dec. 6, 2004 (TW) 93137608

(51) Int. Cl. H02J 7/00

(52) U.S. Cl. 320/145

(57) ABSTRACT

A power supply apparatus is provided. When an electronic apparatus coupled to the power supply is in standby mode, a microprocessor delivers a standby control pulse. A feedback circuit receiving the standby control pulse directs a pulse width modulation (PWM) controller to deliver a periodic intermittent signal. A switching device of the power supply apparatus reduces its switching action to reduce switching power lost upon receipt of activated periodic intermittent signal.

### BACKGROUND

The invention relates to a power supply apparatus, and more particularly, to a switching power supply apparatus able to reduce standby switching power loss when an electronic device is in standby mode.

For improved transfer efficiency, a switching power supply transferring input power to power an electronic device according to a high frequency pulse-width-modulation (PWM) switching signal is often used. However, when the electronic device is in standby mode, power provided by the power supply apparatus is reduced and only power sufficient to keep the standby power saving control circuit working is provided to reduce power consumption.

FIG. 1 is a block diagram of a conventional switching power supply apparatus. A power supply apparatus 1 comprises a rectifier 120, PWM controller 121, power transformer 122, switching device 123, and a feedback circuit 124.

When the power supply apparatus 1 detects the electronic device 130 is in standby mode, a standby control circuit in the PWM control circuit 121 controls a switching pulse which then reduces the frequency of a switching signal directly. Another method uses a burst, the frequency of the switching signal is not changed, but the PWM control circuit 121 stops the output of the switching pulse when in power saving, and re-starts the output of the switching pulse to provide power to the electronic device 130 when the power provided is lower than a predetermined limit.

Therefore, when the electronic device 130 is in standby mode, the conventional power supply apparatus 1 provides not only supply power to the microprocessor of the electronic device 130 required for recovery from standby mode, but also powers the standby control circuit in PWM control circuit 121 to enable PWM control circuit 121 the output of switching signal in standby mode.

However, the power provided to an electronic device is sometimes limited. For example, a portable computer receives power from attached batteries. To extend the battery time of the portable computer, the power consumption of components in the portable computer should be as low as possible. Power used by the standby control circuit when the electronic device is in standby mode creates power losses.

### SUMMARY

The invention provides a power supply apparatus for an electronic device comprising a microprocessor receiving a standby signal and outputting a standby controlling pulse. The power supply apparatus comprises a feedback circuit, a pulse width modulation (PWM) controller, a switching device, and a power transformer. The feedback circuit outputs a first controlling signal when not receiving the standby controlling pulse, and a second controlling signal when receiving the standby controlling pulse. The PWM controller is coupled to an output of the feedback circuit and outputs an intermittent signal continuously when receiving the first controlling signal, and periodically when receiving the second controlling signal. The switching device receives the intermittent signal and outputs a switching control signal by turning ON and OFF according to the high and low levels of the intermittent signal. The power transformer receives the switching control signal, and converts an input power to an output power according to the switching control signal.

The invention also provides an electronic device comprising a circuit outputting a standby signal when in standby mode, a microprocessor receiving the standby signal and outputting a standby controlling pulse, and a power supply apparatus providing power for the electronic device. The power supply apparatus comprises a feedback circuit, a pulse width modulation (PWM) controller, a switching device, and a power transformer. The feedback circuit outputs a first controlling signal when not receiving the standby controlling pulse, and a second controlling signal when receiving the standby controlling pulse. The PWM controller is coupled to an output of the feedback circuit and outputs an intermittent signal continuously when receiving the first controlling signal, and periodically when receiving the second controlling signal. The switching device receives the intermittent signal and outputs a switching control signal by turning ON and OFF according to the high and low levels of the intermittent signal. The power transformer receives the switching control signal, and converts an input power to an output power according to the switching control signal.

The invention further provides a method to provide power to an electronic device receiving a standby signal and outputting a standby controlling pulse. An intermittent signal is outputted continuously when not receiving the standby controlling pulse, and periodically when receiving the standby controlling pulse; a switching control signal is generated according to the intermittent signal. An output power is outputted according to the switching control signal.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### DESCRIPTION OF THE DRAWINGS

The accompanying drawings, incorporated in and constituting a part of this specification, illustrate embodiments of the invention and, together with the description, serve to explain the features, advantages, and principles of the invention.

FIG. 1 is a block diagram of a conventional switching power supply apparatus.

FIG. 2 is a block diagram of a power supply apparatus consistent with a first embodiment of the invention.

FIG. 3A is a circuit schematic of power supply apparatus 2 consistent with the first embodiment of the invention.

FIG. 3B is a circuit schematic of an electronic device connected to the circuit shown in FIG. 3A.

FIG. 4A shows an output waveform of the PWM controller during normal operation.

FIG. 4B shows the standby controlling pulse of the microprocessor.

FIG. 4C shows an output waveform of the PWM controller during standby mode.

FIG. 5 shows a block diagram of an electronic device implementing a power supply apparatus consistent with the invention.

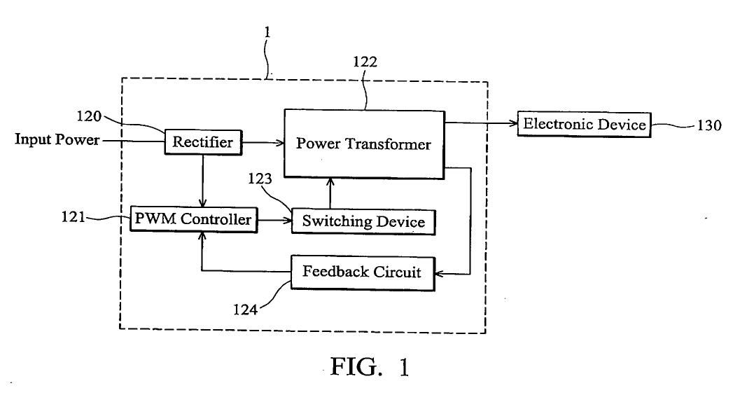

### DETAILED DESCRIPTION

Consistent with the invention, a power supply apparatus is provided such that the PWM control circuit is controlled by the microprocessor when the electronic device is in standby mode, reducing the power used in standby mode.

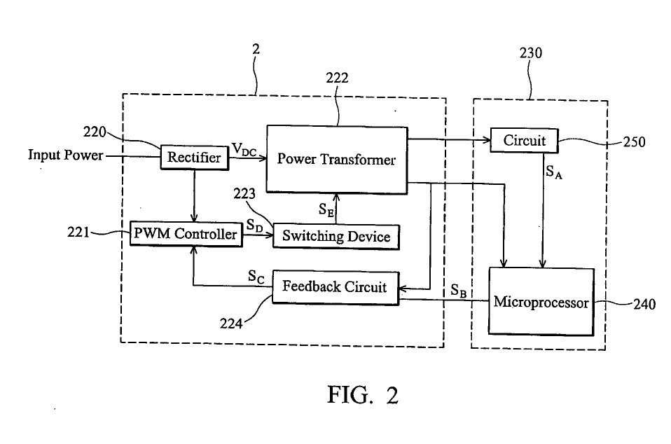

FIG. 2 is a block diagram of a power supply apparatus consistent with a first embodiment of the invention. When an electronic device 230 coupled to a power supply apparatus 2 is in standby mode, a circuit 250 outputs a standby signal SA directing the microprocessor 240 to output a standby controlling pulse S_{B}.

A switching device 223 receives switching signal S_{D}, then executes ON and OFF operation accordingly to output a switching control signal S_{E}. A power transformer 222 receives the switching control signal S_{E} and converts input power V_{DC} to output power according to the switching control signal S_{E}. A rectifier 220 is coupled to an AC power and provides the input power VDC. A feedback circuit 224 is coupled to a power transformer 222 and an output terminal of the microprocessor 240. The feedback circuit 224 outputs a first controlling signal when not receiving the standby controlling pulse S_{B}, and outputs a second controlling signal when receiving the standby controlling pulse S_{B}. The first controlling signal and the second controlling signal are transferred via the feedback signal S_{C} line. The PWM controller 221 is coupled to receive the feedback signal S_{C} and outputs an output signal S_{D} accordingly. The PWM controller 221 outputs a intermittent signal continuously when receiving the first controlling signal, and outputs the intermittent signal periodically when receiving the second controlling signal. Thus, the switching device 223 directs the power transformer 222 to output a standby power to maintain the minimum power of the microprocessor 240 according to the output signal S_{D} of the PWM controller 221.

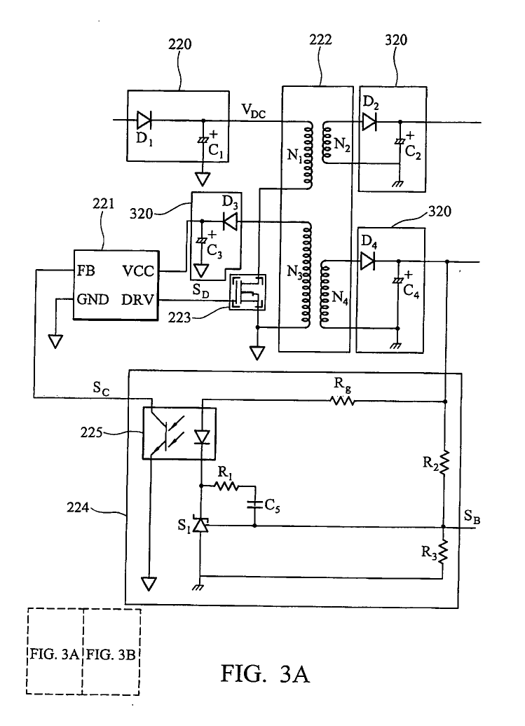

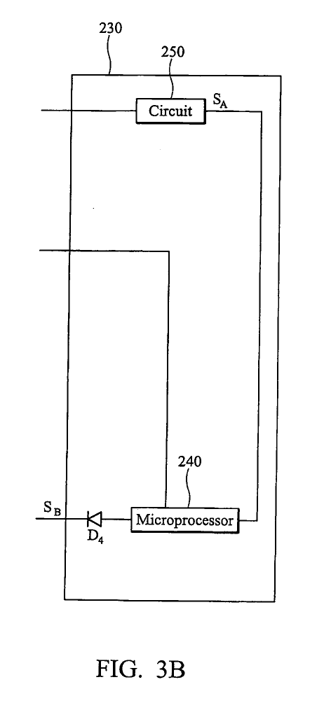

FIG. 3A is a circuit schematic of the power supply apparatus 2 consistent with the first embodiment of the invention. FIG. 3B is a circuit schematic of an electronic device connected to the circuit shown in FIG. 3A. Power transformer 222 comprises a first coil N1 receiving a DC power V_{DC} provided by the rectifier 220, a second coil N2 providing power for circuit 250, a third coil N3 providing power for the PWM controller 221; and a fourth coil N4 providing power for the microprocessor 240. Each of the second coil N2, the third coil N3 and the fourth coil N4 can have a rectifier 320 to provide stable power.

When electronic device 230 is under normal operation, the feedback circuit 224 controls the duty-cycle of the output signal S_{D} of the PWM controller 221 according to a feedback of the power output. The switching device 223 adjusts the output power of the power transformer 222 according to the output signal S_{D}.

When the electronic device 230 is in standby mode, the circuit 250 outputs a standby signal S_{A} directing the microprocessor 240 to output the standby controlling pulse S_{B} and cut the power supply circuit between the power and the circuit 250. When a high standby controlling pulse S_{B} is received by the feedback circuit 224, the shunt regulator S1 is ON′ driving optical coupler 225 to output a high signal. When a low standby controlling pulse S_{B} is received, the shunt regulator S1 is OFF and driving optical coupler 225 to output a low signal.

Thus, when the feedback circuit receives the standby controlling pulse S_{B}, the second controlling signal is sent to direct the PWM controller 221 to output a intermittent signal periodically. In this embodiment, the PWM controller is a PWM controller IC and the switching device 223 is a MOSFET.

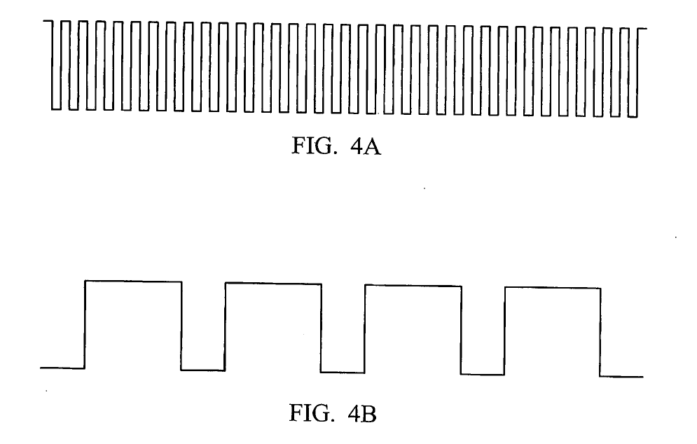

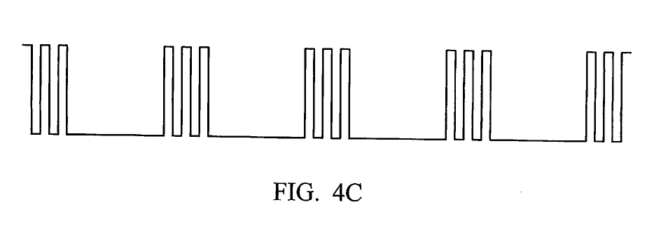

FIGS. 4A-4C show the control waveform of the power apparatus consistent with the first embodiment of the invention. FIG. 4A is the output waveform of the PWM controller under normal operation. FIG. 4B is the standby controlling pulse of the microprocessor. FIG. 4C is the output waveform of the PWM controller in standby mode.

FIG. 4A shows output waveform of the PWM controller under normal operation to be a continuous intermittent signal. When the electronic device 230 is in standby mode, the microprocessor outputs the standby controlling pulse as shown in FIG. 4B. The feedback circuit then directs the PWM controller 221 to output a periodic intermittent signal according to the standby controlling pulse, as shown in FIG. 4C.

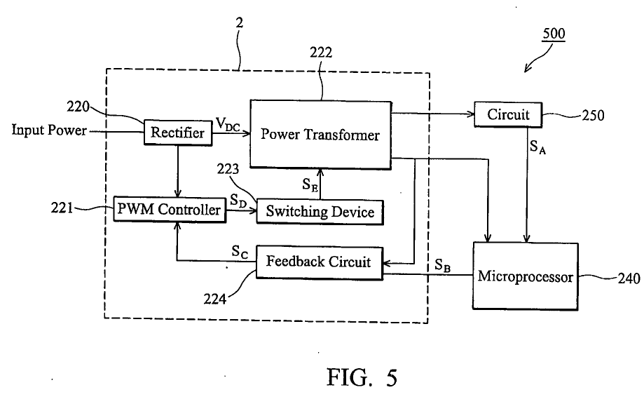

In addition, the power supply consistent with the invention is suitable for application in electronic devices, as shown in FIG. 5, to save power consumption in standby mode.

The electronic device 500 shown in FIG. 5 comprises a circuit 250, a microprocessor 240 and a power supply apparatus 2. For example, the electronic device 500 can be a LCD device while the circuit 250 is a LCD panel. The relationship between the power supply apparatus 2, the circuit 250 and the microprocessor 240 is the same as described and therefore is not repeated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A power supply apparatus for supplying power to an electronic device comprising a microprocessor, receiving a standby signal and outputting a standby controlling pulse, comprising:
a feedback circuit, outputting a first controlling signal when not receiving the standby controlling pulse, and outputting a second controlling signal when receiving the standby controlling pulse;
a pulse width modulation (PWM) controller coupled to an output of the feedback circuit, outputting a intermittent signal continuously when receiving the first controlling signal, and outputting the intermittent signal periodically when receiving the second controlling signal;
a switching device receiving the intermittent signal, and outputting a switching control signal by turning ON and OFF according to the intermittent signal; and
a power transformer receiving the switching control signal, and transforming an input power, according to the switching control signal, to an output power.

2. A power supply apparatus as claimed in claim 1, wherein the feedback circuit comprises at least a shunt regulator and an optical coupler.

3. A power supply apparatus as claimed in claim 2, wherein the shunt regulator directs the optical coupler to output the second controlling signal according to the standby controlling pulse when the feedback circuit receives the standby controlling pulse.

4. A power supply apparatus as claimed in claim 1, wherein the electronic device is a liquid crystal display device.

5. An electronic device comprising:
a circuit outputting a standby signal when in standby mode;
a microprocessor receiving the standby signal and outputting a standby controlling pulse; and
a power supply apparatus providing power for the electronic device, comprising:
a feedback circuit, outputting a first controlling signal when not receiving the standby controlling pulse, and outputting a second controlling signal when receiving the standby controlling pulse;
a pulse width modulation (PWM) controller coupled to an output of the feedback circuit, outputting a intermittent signal continuously when receiving the first controlling signal, and outputting the intermittent signal periodically when receiving the second controlling signal;
a switching device receiving the intermittent signal, and outputting a switching control signal by turning ON and OFF according to the intermittent signal; and
a power transformer receiving the switching control signal, and transforming an input power, according to the switching control signal, to an output power.

6. An electronic device as claimed in claim 5, wherein the feedback circuit comprises at least a shunt regulator and an optical coupler.

7. An electronic device as claimed in claim 6, wherein the optical coupler outputs the second controlling signal according to the standby controlling pulse when the feedback circuit receives the standby controlling pulse.

8. An electronic device as claimed in claim 5, wherein the electronic device is a liquid crystal display device.

9. A method to provide power to an electronic device receiving a standby signal and selectively outputting a standby controlling pulse, comprising:
outputting a intermittent signal continuously when not receiving the standby controlling pulse;
outputting the intermittent signal periodically when receiving the standby controlling pulse;
outputting a switching control signal according to the intermittent signal; and
outputting an output power according to the switching control signal.
